(19) United States
(12) Patent Application Publication
(10) Pub. No.: US 2011/0199321 A1
(43) Pub. Date: Aug. 18, 2011

(54) APPARATUS FOR PROVIDING SELF-MORPHABLE HAPTIC AND VISUAL INFORMATION AND METHOD THEREOF

(75) Inventors: Ki-Uk Kyung, Daejeon (KR); Il-Yeon Cho, Daejeon (KR); Jun-Seok Park, Daejeon (KR); Dong-Woo Lee, Daejeon (KR); Jeun-Woo Lee, Daejeon (KR); Dong-Won Han, Daejeon (KR)

(73) Assignee: Electronics and Telecommunications Research Institute, Daejeon (KR)

(21) Appl. No.: 12/972,316

(22) Filed: Dec. 17, 2010

(30) Foreign Application Priority Data
Feb. 12, 2010 (KR) 10-2010-0013641
Jul. 7, 2010 (KR) 10-2010-0065497

(51) Int. Cl. G06F 3/041; G09G 5/00

(52) U.S. Cl. 345/173; 345/204

(57) ABSTRACT

A self-morphable haptic and visual information providing apparatus includes: a display unit configured to provide haptic information through a physical shape variation of a display screen; and a haptic element driving unit configured to generate a driving signal for providing the haptic information.

### CROSS-REFERENCE(S) TO RELATED APPLICATIONS

The present application claims priority of Korean Patent Application Nos. 10-2010-0013641 and 10-2010-0065497, filed on Feb. 12, 2010, and Jul. 07, 2010, respectively, which are incorporated herein by reference in their entirety.

### BACKGROUND OF THE INVENTION

1. Field of the Invention

Exemplary embodiments of the present invention relate to a displaying device and controlling method thereof; and, more particularly, to an apparatus and method for providing self-morphable haptic and visual information through a display screen.

2. Description of Related Art

As the use of displaying devices to provide information to users such as a mobile terminal is popularized and the performance of the displaying devices is advanced, a variety of methods for providing user input information have been proposed. There are a phone book function, a short message composition function, and an electronic note function which are implemented in the displaying devices. These functions enable the users to easily use the devices and the corresponding function. One of generally used to input or provide information to users is button-type device, and another is touch screen or touch panel. The contemporary button-type device is well-known as in a computer keyboard or cellular phone keypad. And nowadays the use of touch screen to input information is extending steadily.

A method of input information using touch screen is to input information through a displaying device providing information to users. Therefore, the input method using a touch screen is frequently used for performing a phone book function, a scheduler function, a short message composition function, a personal information management function, an Internet access function, and an electronic dictionary function in a personal digital assistant (PDA), a smart phone combined with a mobile phone or an Internet phone, because it provides a convenient user interface. In current mobile terminals using a touch screen, a capacitive scheme or resistive scheme is most frequently adopted.

To compare the input method using a touch screen with the input method using mechanical key buttons as a method to input information, the input method using mechanical key buttons has more merit than the input method using a touch screen in view of providing a click feeling of pushing mechanical key buttons. Users may perform a desired operation while seeing a flat screen, and may easily manipulate the touch screen. Therefore, the touch screen method is considered to be the most ideal input method in a graphical user interface (GUI) environment.

Different from a typical keypad having a plurality of mechanical key buttons, the touch screen provides soft buttons. Therefore, the touch screen does not provide a click feeling to users. That is, since the touch screen has a flat surface, users cannot detect a click feeling from the soft buttons when selecting a key button.

### SUMMARY OF THE INVENTION

An embodiment of the present invention is directed to haptic and visual information providing apparatus and method capable of providing visual information and haptic information through a display screen at the same time.

Another embodiment of the present invention is directed to haptic and visual information providing apparatus and method capable of providing haptic information which is generated when a key button is selected.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a haptic and visual information providing apparatus includes: a display unit configured to provide haptic information through a physical shape variation of a display screen; and a haptic element driving unit configured to generate a driving signal for providing the haptic information.

The display unit may include a haptic element array configured to operate in response to the driving signal, and the haptic element array includes at least one haptic element to provide the haptic information.

The display unit further may further include: a touch sensor layer configured to generate a user input signal according to a user's touch; and a visual display layer configured to provide visual information.

Any one of the touch sensor layer and the visual display layer may be positioned over a haptic sensor, and have such a flexible structure as to provide haptic information according to an operation of the haptic sensor.

The haptic and visual information providing apparatus may further include a control unit configured to control the haptic element driving unit to drive haptic elements corresponding to the visual information displayed through the visual display layer.

The visual information may include key button information which contains information on at least one of a menu key, a function key, a number key, a character key, a special key, a special character key, and an arrow key.

The haptic element may operate in a direction perpendicular to the display screen.

The haptic element may include a linear actuator, and the linear actuator may include: a transducer configured to perform a repetitive movement in a vertical direction according to the driving signal; a movable shaft configured to reciprocate in the vertical direction according to the repetitive movement; and a rotor configured to move on the movable shaft along the movable shaft.

The haptic element may include an electro active element, and the electro active element may include: an electro active material of which the size changes according to the driving signal; and an elastic element which is attached to the surface of the electro active material and of which the height is elastically changed in the vertical direction.

The haptic element may include a visual display element which is combined to display the visual information.

In accordance with another embodiment of the present invention, a haptic and visual information providing method includes: detecting that haptic information is to be provided through a display screen; selecting haptic elements to provide the haptic information, when the providing of the haptic information is detected; generating driving signals for driving the selected haptic elements; and driving the selected haptic elements according to the driving signals and providing haptic information through a physical shape variation of the display screen.

The haptic and visual information providing method may further include simultaneously providing visual information corresponding to the haptic information through the display screen.

The visual information may include key button information which contains information on at least one of a menu key, a function key, a number key, a character key, a special key, a special character key, and an arrow key.

Said driving the selected haptic elements according to the driving signals and providing the haptic information through the physical shape variation of the display screen may include driving the haptic elements in a direction perpendicular to the display screen and providing the haptic information through a physical shape variation of the display screen.

### BRIEF DESCRIPTION OF THE DRAWINGS

FIG. 1 is a diagram illustrating the configuration of a haptic and visual information providing apparatus in accordance with an embodiment of the present invention.

FIGS. 2A to 2C are diagrams illustrating examples of a display screen of a display unit illustrated in FIG. 1.

FIG. 3 is a diagram illustrating a first example of the display unit in accordance with the embodiment of the present invention.

FIG. 4 is a diagram illustrating a second example of the display unit in accordance with the embodiment of the present invention.

FIG. 5 is a diagram illustrating a third example of a display unit in accordance with the embodiment of the present invention.

FIG. 6A is a diagram illustrating a linear actuator forming a haptic element in accordance with the embodiment of the present invention.

FIG. 6B is a diagram illustrating a case in which a head is attached to the linear actuator of FIG. 6A.

FIG. 6C is a diagram illustrating a haptic element array including the linear actuators of FIG. 6A.

FIG. 7 is a diagram illustrating an electro active element forming the haptic element in accordance with the embodiment of the present invention.

FIG. 8A is a diagram illustrating a haptic and visual display element forming the haptic element in accordance with the embodiment of the present invention.

FIG. 8B is a diagram illustrating a haptic element array including the haptic and visual display elements of FIG. 8A.

FIG. 9 is a flowchart of the method to provide a haptic and visual information in the haptic and visual information providing apparatus depicted in FIG. 1.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

A haptic and visual information providing apparatus in accordance with an embodiment of the present invention may provide haptic and visual information through a display unit.

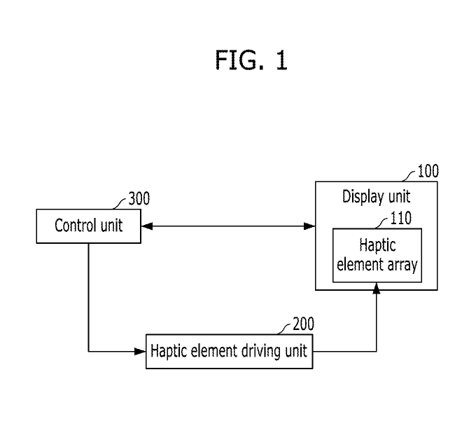

FIG. 1 is a diagram illustrating the configuration of the haptic and visual information providing apparatus in accordance with the embodiment of the present invention.

Referring to FIG. 1, the haptic and visual information providing apparatus includes a display unit 100, a haptic element driving unit 200, and a control unit 300. The display unit 100 may include a haptic element array 110 having at least one haptic element.

The display unit 100 is configured to display an image according to visual information provided to the haptic and visual information providing apparatus. Each of the haptic elements included in the haptic element array 110 operates in response to a driving signal for driving the haptic element. The display unit 100 provides haptic information to a user through the haptic element array 110.

The display unit 100 deforms the physical external shape of the display screen by driving haptic elements positioned under the display screen. For example, the display unit 100 may display a plurality of key buttons for user input through the display screen. The key buttons may include at least one or more of a menu key, a function key, a number key, a character key, a special key, a special character key, and an arrow key. The display unit 100 may provide haptic information as well as visual information through the operation of haptic elements positioned under the displayed key buttons.

Examples of the display unit 100 may include a touch screen. In this case, the display unit 100 may serve as an output unit configured to display visual information or serve as an input unit configured to receive information according to a user's manipulation.

The haptic element driving unit 200 is configured to generate a driving signal for driving each of the haptic elements of the display unit 100. The driving signal may include a variety of signals corresponding to the haptic elements, such as an electrical signal, a voltage signal, a current signal, a potential difference providing signal, a frequency signal and so on, depending on the characteristics of the haptic elements. Therefore, the haptic element driving unit 200 may generate a driving signal corresponding to the haptic element.

The control unit 300 is configured to control the overall operations of the haptic and visual information providing apparatus. Furthermore, when sensing that haptic information needs to be provided through the display unit, the control unit 300 controls the haptic element driving unit 200 to drive haptic elements corresponding to a display region to which the haptic information is to be provided. The control unit 300 may provide coordinate information and driving signal magnitude (intensity) information for selecting haptic elements within the haptic element array 110.

The control unit 300 receives a user input signal provided through the display unit 100 and performs a control operation corresponding to the user input signal.

Meanwhile, the function of the haptic element driving unit 200 may be included in the control unit 300.

As described above, the haptic and visual information providing apparatus in accordance with the embodiment of the present invention may provide visual information and haptic information to a user at the same time.

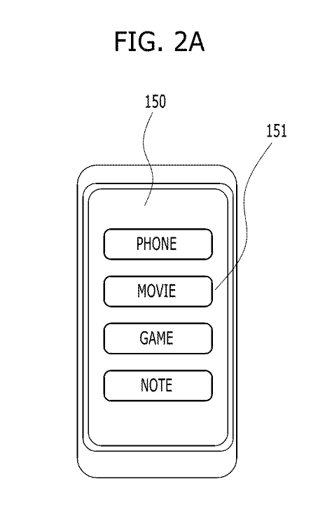

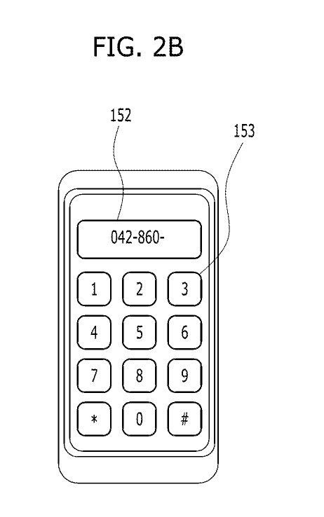

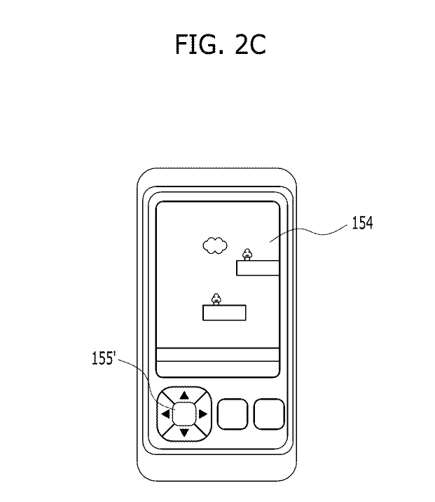

FIGS. 2A to 2C are diagrams illustrating examples of the display screen of the display unit illustrated in FIG. 1.

FIGS. 2A to 2C illustrate display screens 150 of the display unit 100.

FIG. 2A illustrates an example of an operation mode selection screen of the haptic and visual information providing apparatus. In FIG. 2A, menu keys 151 are displayed and include a phone menu key, a move menu key, a game menu key, and a note menu key.

The phone menu key is a menu key for selecting a phone mode, the move menu key is a menu key for selecting a move mode, the game menu key is a menu key for selecting a game mode, and the note menu key is a menu key for selecting a memo mode.

FIG. 2B illustrates an example of the phone mode screen of the haptic and visual information providing apparatus. In FIG. 2B, a phone number output region 152 and number keys 153 for inputting a phone number are displayed.

FIG. 2C illustrates an example of the game mode screen of the haptic and visual information providing apparatus. In FIG. 2C, a game screen 154 and function keys 155 for game manipulation are displayed.

In this embodiment, when a key button such as a menu key 151, a number key 153, or a function key 155 is selected on the screen of FIG. 2A, 2B, or 2C, the haptic and visual information providing information apparatus physically changes the display screen 150. Therefore, the haptic and visual information providing apparatus may provide a feeling of key buttons having an actual button shape.

Accordingly, the haptic and visual information providing apparatus in accordance with the embodiment of the present invention may simultaneously provide visual information such as a key button image and haptic information such as a physical shape deformation of a key button. That is, the haptic and visual providing apparatus in accordance with the embodiment of the present invention may provide a user with a touch feeling which seems like touching an actual key-shaped button, through the display screen 150.

However, this is only an example, and the embodiment of the present invention may be extended and applied to a variety of functions requiring a physical shape variation. For example, the haptic and visual information providing apparatus may provide haptic information to GUI operations such as scrolling and dragging other than the key button manipulation. Furthermore, the haptic and visual information providing apparatus may provide haptic information to state changes such as vibration, collision, and pressure change. Furthermore, the haptic and visual information providing apparatus may provide visual information combined with haptic information.

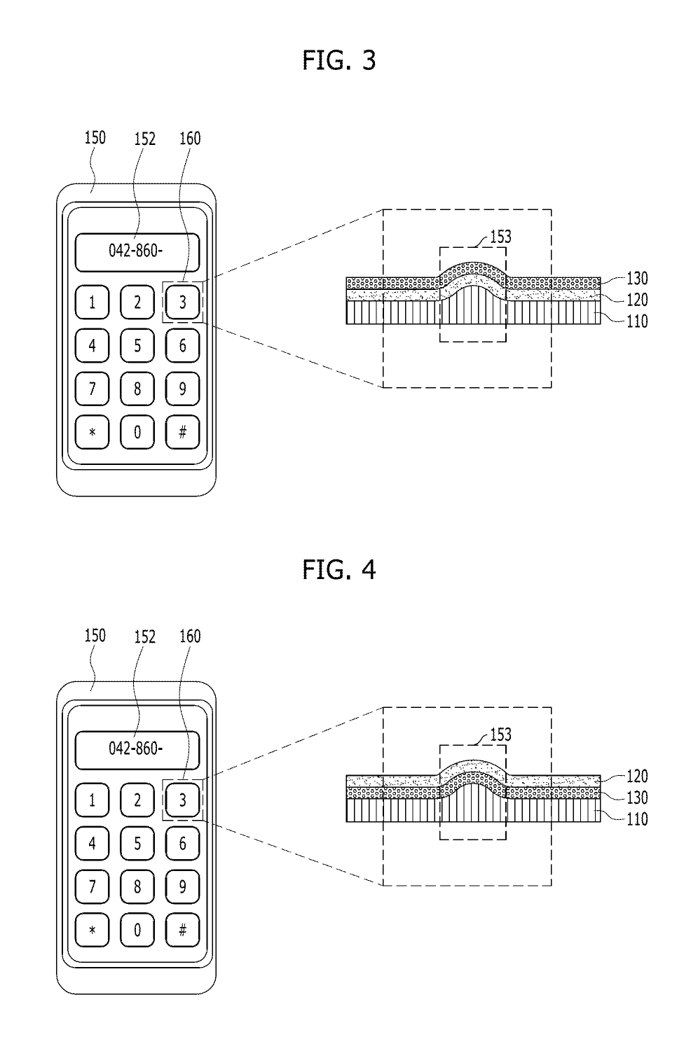

FIG. 3 is a diagram illustrating a first example of the display unit in accordance with the embodiment of the present invention.

FIG. 3 illustrates a display screen 150 of the display unit 100. The display screen 150 displays the phone mode screen as an example. The phone number output region 152 is a region on which a phone number inputted or selected by a user is displayed.

FIG. 3 illustrates a display region 160 for explaining the structure of the display unit 100. The display region 160 is a partial region of the display screen 150. The display region 160 includes a number key 153 corresponding to ‘3’. FIG. 3 includes a side view of the display region 160, focusing on the number key 153 of the display unit 100.

Referring to the side view, the display unit 100 includes a haptic element array 110, a visual display layer 120, and a touch sensor layer 130.

The haptic element array 110 is a region including a plurality of haptic elements. The visual display layer 120 includes display elements configured to display image data. The touch sensor layer 130 includes a plurality of touch sensors configured to generate an input signal according to a user's touch.

The haptic element array 110 is positioned at the lowermost part, the touch sensor layer 130 is positioned at the uppermost part, and the visual display layer 120 is positioned between the haptic element array 110 and the touch sensor layer 130.

In order to express haptic information by driving haptic elements, the visual display layer 120 and the touch sensor layer 130 positioned over the haptic element array 110 are formed of a flexible material to provide the haptic information. The haptic elements are driven to change the physical shapes of the visual display layer 120 and the touch sensor layer 130. Furthermore, the touch sensor layer 130 may be formed of a transparent material to output visual information, for example, image data displayed through the visual display layer 120.

The haptic elements may be deformed in a direction perpendicular to the surface of the display screen 150, for example. Therefore, the display unit 100 may provide haptic information to a user through the deformations of the respective haptic elements.

The side view of FIG. 3 illustrates a physical shape variation of the number key 153 according to the deformation of the haptic elements positioned under the number key 153.

The haptic and visual providing apparatus in accordance with the embodiment of the present invention may provide a user with a touch feeling which seems like touching an actual key button, when the user touches the number key 153.

FIG. 4 is a diagram illustrating a second example of the display unit in accordance with the embodiment of the present invention.

FIG. 4 illustrates a display screen 150 of the display unit 100. The display screen 150 displays the phone mode screen as an example. The phone number output region 152 is a region on which a phone number inputted or selected by a user is displayed.

FIG. 4 illustrates a display region 160 for explaining the structure of the display unit 100. The display region 160 is a partial region of the display screen 150. The display region 160 includes a number key 153 corresponding to ‘3’. FIG. 4 includes a side view of the display region 160, focusing on the number key 153 of the display unit 100.

Referring to the side view, the display unit 100 includes a haptic element array 110, a visual display layer 120, and a touch sensor layer 130.

The haptic element array 110, the visual display layer 120, and the touch sensor layer 130 in the display unit 100 may be configured in the same manner as those of FIG. 3.

The haptic element array 110 is positioned at the lowermost part, the visual display layer 120 is positioned at the uppermost part, and the touch sensor layer 130 is positioned between the haptic element array 110 and the visual display layer 120.

In FIG. 3, the visual display layer 120 is positioned between the touch sensor layer 130 and the haptic element array 110, and the touch sensor layer 130 is positioned at the uppermost part. In FIG. 4, however, the positions of the visual display layer 120 and the touch sensor layer 130 are reversed.

In order to express haptic information by driving haptic elements, the touch sensor layer 130 and the visual display layer 120 positioned over the haptic element array 110 are formed of a flexible material to provide the haptic information. The haptic elements are driven to change the physical shapes of the visual display layer 120 and the touch sensor layer 130.

The haptic elements may be deformed in a direction perpendicular to the surface of the display screen 150, for example. Therefore, the display unit 100 may provide haptic information to a user through the deformations of the respective haptic elements.

The side view of FIG. 3 illustrates a physical shape variation of the number key 153 according to the deformation of the haptic elements positioned under the number key 153.

The haptic and visual providing apparatus in accordance with the embodiment of the present invention may provide a user with a touch feeling which seems like touching an actual key button, when the user touches the number key 153.

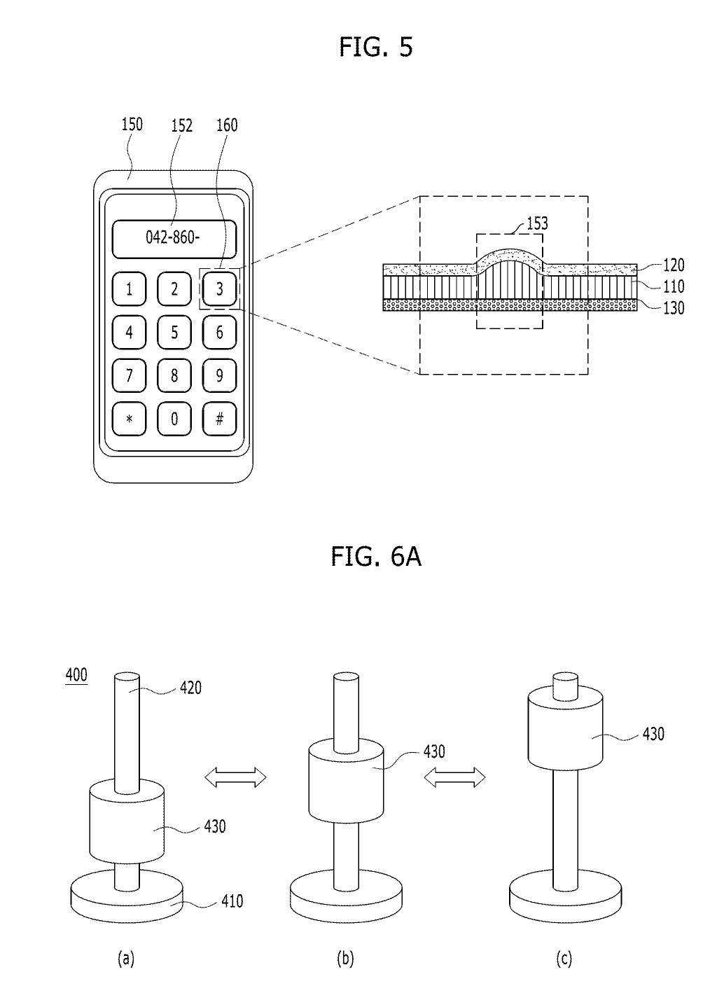

FIG. 5 is a diagram illustrating a third example of a display unit in accordance with the embodiment of the present invention.

FIG. 5 illustrates a display screen 150 of the display unit 100. The display screen 150 displays the phone mode screen as an example. The phone number output region 152 is a region on which a phone number inputted or selected by a user is displayed.

FIG. 5 illustrates a display region 160 for explaining the structure of the display unit 100. The display region 160 is a partial region of the display screen 150. The display region 160 includes a number key 153 corresponding to ‘3’. FIG. 5 includes a side view of the display region 160, focusing on the number key 153 of the display unit 100.

Referring to the side view, the display unit 100 includes a haptic element array 110, a visual display layer 120, and a touch sensor layer 130.

The haptic element array 110, the visual display layer 120, and the touch sensor layer 130 in the display unit 100 may be configured in the same manner as those of FIG. 3.

The touch sensor layer 130 is positioned at the lowermost part, the visual display layer 120 is positioned at the uppermost part, and the haptic element array 110 is positioned between the visual display layer 120 and the touch sensor layer 130.

In order to express haptic information by driving haptic elements, the visual display layer 120 positioned over the haptic element array 110 is formed of a flexible material to provide the haptic information. The haptic elements are driven to change the physical shape of the visual display layer 120.

The haptic elements may be deformed in a direction perpendicular to the surface of the display screen 150, for example. Therefore, the display unit 100 may provide haptic information to a user through the deformation of the respective haptic elements.

The side view of FIG. 5 illustrates a physical shape variation of the number key 153 according to the deformation of the haptic elements positioned under the number key 153.

The structure of the display unit 100 in FIG. 5 may be applied to a case in which the structure of the touch sensor layer 130 is difficult to form into a flexible structure or is not flexible. At this time, the touch sensor layer 130 is positioned under the haptic element array 110.

The haptic and visual providing apparatus in accordance with the embodiment of the present invention may provide a user to a touch feeling which seems like touching an actual key button, when the user touches the number key 153.

Therefore, the display screen 150 in accordance with the embodiment of the present invention may include at least one of the visual display layer 120 positioned over the haptic element array 110 and the touch sensor layer 130.

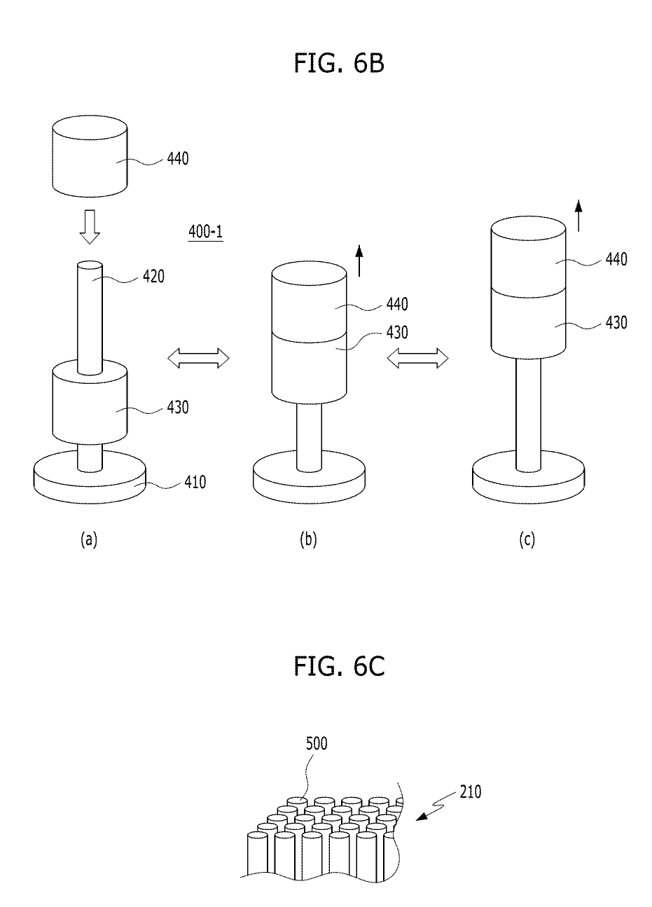

FIG. 6A is a diagram illustrating a linear actuator forming the haptic element in accordance with the embodiment of the present invention.

Referring to FIG. 6A, the haptic element may be implemented as the linear actuator 400.

The linear actuator 400 includes a transducer 410, a movable shaft 420, and a rotor 430.

The transducer 401 may include a disk-type transducer based on the bimorph principle. The transducer 410 is a piezoelectric material which quickly reacts to a potential difference to generate a displacement.

The movable shaft 420 is coupled to the transducer 410 and minutely reciprocates in a vertical direction according to the repetitive movement of the transducer 410 of which the shape becomes convex or concave.

The rotor 430 surrounds the movable shaft 420, and moved together with or separately from the movable shaft 420 depending on the movement speed of the movable shaft 420. When the movement speed of the movable shaft 420 is low, the rotor 430 is moved together with the movable shaft 420. However, when the movement speed of the movable shaft 420 is high, the rotor 430 comes in sliding contact with the movable shaft 420.

Therefore, in a state in which the movable shaft 420 is fixed, the position of the rotor 430 of the linear actuator 400 may be minutely changed according to an instant operation of the transducer 410. The transducer 410 is formed of a piezoelectric material, such as piezoelectric ceramic or piezoelectric polymer, which very quickly reacts to an electrical signal, and may operate even at a frequency of several tens KHz or more. Therefore, even when the transducer 410 operates at a high frequency, the rotor 430 may be moved in a desired direction by several tens of millimeters or more per second.

For example, the rotor 430 may be moved to a position (a), (b), or (c) on the movable shaft 420 in FIG. 6A.

The linear actuator 400 may include an ultrasonic linear actuator. Ultrasonic waves have a frequency higher than the audio frequency of 20 KHz, and thus human beings cannot hear the ultrasonic waves. Accordingly, an actuator which operates at a frequency corresponding to the ultrasonic wave range refers to an ultrasonic linear actuator. The linear actuator 400 in accordance with the embodiment of the present invention may include linear actuators of which the rotor 430 is moved along the movable shaft 420, as well as the ultrasonic linear actuator.

The linear actuator 400 has a small size and does not generate noise. Furthermore, since the linear actuator 400 has small power consumption, a plurality of linear actuators may be used to generate a variety of deformation shapes. The deformation shapes may be used to generate a variety of haptic information.

The linear actuator 400 deforms the visual display layer 120 or the touch sensor layer 130 through the movement of the rotor 430.

FIG. 6B is a diagram illustrating a case in which a head is attached to the linear actuator of FIG. 6A.

Referring to FIG. 6B, a haptic element, for example, a linear actuator 400-1 additionally includes a lid-shaped head 440 attached to the linear actuator 400 of FIG. 6A. The linear actuator 400-1 includes a transducer 410, a movable shaft 420, a rotor 430, and the head 440. The detailed structure of the linear actuator 400-1 excluding the head 440 may be constructed in the same manner as that of FIG. 6A.

In a state in which the movable shaft 420 is fixed, the head 440 is attached to the upper end of the rotor 430. The head 440 of the linear actuator 400-1 is vertically moved together with the rotor 430 along the movable shaft 420.

In FIG. 6B, (a) indicates the linear actuator 400-1 having the head 440 attached thereto, and (b) and (c) indicate a state in which the rotor 430 and the head 440 are moved together in a vertical direction.

The linear actuator 400-1 deforms the visual display layer 120 or the touch sensor layer 130 through the movement of the rotor 430 and the head 440.

FIG. 6C is a diagram illustrating a haptic element array including the linear actuators of FIG. 6A.

Referring to FIG. 6C, the haptic element array 110 of the display unit 100 includes a plurality of linear actuators 400. The haptic element array 110 may include a plurality of linear actuators 400 which are arranged in lines and rows under the display screen, in order to provide haptic information.

The haptic element array 110 may include the linear actuators 400 of FIG. 6A or the linear actuators 400-1 of FIG. 6B.

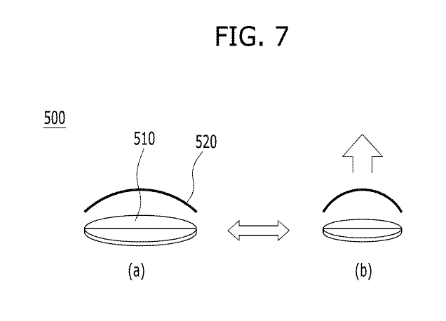

FIG. 7 is a diagram illustrating an electro active element in accordance with the embodiment of the present invention.

Referring to FIG. 7, the electro active element 500 includes an electro active material 510 and an elastic lid 520.

When a potential difference is applied, the size or volume of the electro active material changes (increases or decreases). For example, the electro active material 510 includes a piezoelectric material, an electro active polymer (EAP), and polyvinyl-lidene fluoride (PVDF).

The elastic lid 520 may be attached to the surface of the electro active material 510. At this time, as the size of the electro active material 510 changes, the height of the elastic lid 520 changes in a vertical direction. The elastic lid 520 may have such sufficient elasticity that the shape thereof changes according to the size change of the electro active material 510. The elastic lid 520 may be formed of a polymer material which may be deformed.

The electro active element 500 deforms the visual display layer 120 or the touch sensor layer 130 through the height change of the elastic lid 520.

Furthermore, a plurality of electro active elements 500 may be arranged in a similar form to the arrangement of the linear actuators 400 of FIG. 6C, thereby forming the haptic element array 110.

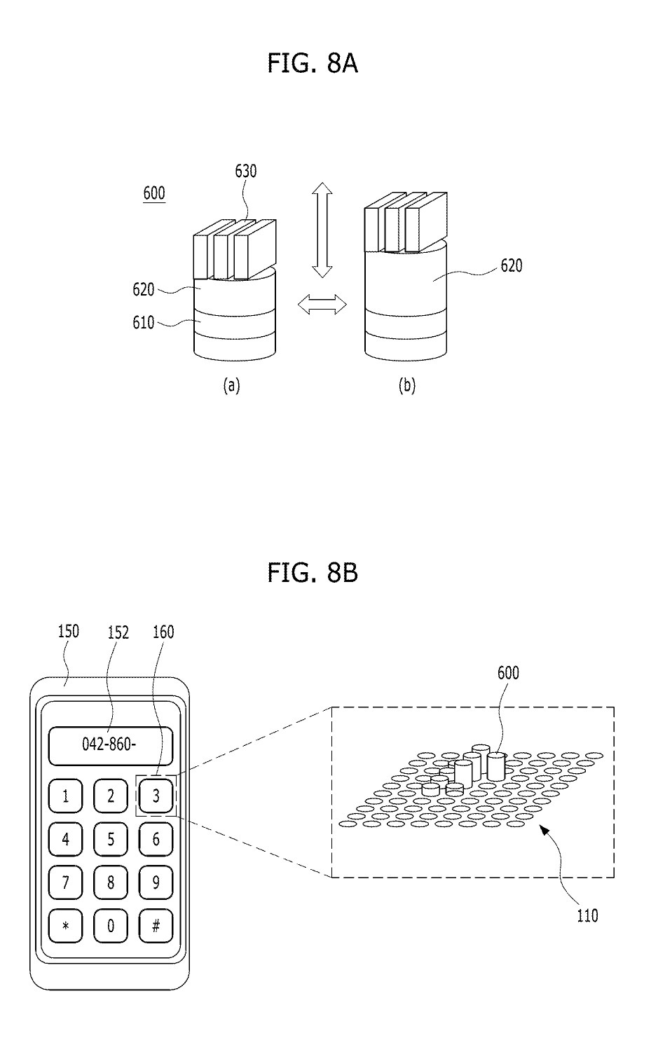

FIG. 8A is a diagram illustrating a haptic and visual display element composing the haptic element in accordance with the embodiment of the present invention.

Referring to FIG. 8A, the haptic and visual display element 600 includes a pressure sensor 610, a haptic element 620, and a visual display element 630. That is, the haptic and visual display element 600 may be constructed by combining an element for providing visual information and an element for providing haptic information, and may provide visual information and haptic information at the same time.

The pressure sensor 610 is a sensor capable of measuring a pressure, and generates pressure information for a user's touch or the like. The generated pressure information may be provided to the control unit 300 or the like. As the thickness of the pressure sensor 610 decreases, it is easy to implement the haptic and visual display element 600. Examples of the pressure sensor 610 include a force sensitive resistor (FSR) sensor and a PVDF sensor.

The haptic element 620 may provide haptic information in a direction perpendicular to the display screen. The haptic element 620 may include a variety of haptic elements as illustrated in FIGS. 6A, 6B, and 7. Depending on the driving method of the haptic element 620, the haptic element illustrated in FIG. 6A or 6B may be used.

As the haptic element 620 is vertically deformed, the haptic and visual display element 600 may exhibit a movement pattern as illustrated in FIG. 8A.

The visual display element 630 may be implemented as a light emitting diode (LED), for example. In this case, the visual display element 630 may include a combined LED capable of displaying three primary colors (RGB) or a plurality of LEDs capable of displaying three primary colors, respectively.

The visual display element 630 may be positioned at the uppermost part of the haptic and visual display element 600, the pressure sensor 610 may be positioned at the lowermost part of the haptic and visual display element 600, and the haptic element 620 is positioned between the visual display element 630 and the pressure sensor 610. This structure is only an example, and the positions of the respective modules in the haptic and visual display element 600 may be changed depending on the characteristics of the element.

FIG. 8B is a diagram illustrating a haptic element array including the haptic and visual display elements of FIG. 8A.

FIG. 8B illustrates the display screen 150 of the display unit 100. The display screen 150 displays the phone mode screen, for example. The phone number output region 152 is a region on which a phone number inputted or selected by a user is displayed.

In FIG. 8B, a display region 160 of the display unit 100 is illustrated. The display region 160 is a partial region of the display screen 150. The display region 160 includes a number key. The display region 160 includes a haptic element array 110 focusing on the number key of the display unit 100.

Under the display region 160, a plurality of haptic and visual display elements 600 may be arranged in lines and rows to provide haptic information.

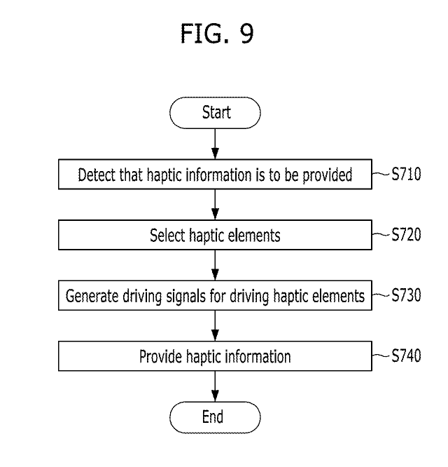

FIG. 9 is a flow chart showing a haptic and visual information providing method of the haptic and visual information providing apparatus illustrated in FIG. 1.

Referring to FIG. 9, the control unit 300 detects that haptic information is to be provided, at step S710. For example, the control unit 300 may detects a time point at which haptic information is to be provided, according to a user's selection or a setting inside the haptic and visual information providing apparatus.

At step S720, the control unit 300 selects haptic elements to provide haptic information, in the haptic element array 110. The haptic element array 110 is positioned under the display screen, and includes a plurality of haptic elements arranged to display haptic information.

At step S730, the haptic element driving unit 200 generates a driving signal for driving the haptic elements selected by the control unit 300, according to the control of the control unit 300. The control unit 300 may control the deformation height of each haptic element in a vertical direction by controlling the magnitude or intensity of the driving signal provided to the haptic element.

At step S740, the display unit 100 drives the haptic elements corresponding to the driving signals of the haptic element driving unit 200. The display unit 100 may provide haptic information by driving the haptic elements. As the haptic elements are driven, the physical external shape of the display screen of the display unit 100 is varied.

When the providing of the haptic information is completed at the step S740, the display unit 100 terminates the process.

The haptic elements included in the haptic element array 110 in accordance with the embodiment of the present invention may be deformed in a direction perpendicular to the display screen. Furthermore, as the size of the haptic elements included in the haptic element array 110 decreases or the number of haptic elements increases, the haptic information may be expressed with precision.

The haptic and visual information providing apparatus in accordance with the embodiment of the present invention may be applied to information terminal devices including a haptic-type touch screen. Examples of the information terminal devices include a personal computer (PC), a notebook computer, a net-book computer, a mobile phone, a media player (PMP or MP3 player), a game machine, a monitor, a printer, and a photocopier.

The haptic and visual information providing apparatus in accordance with the embodiment of the present invention not only provides visual information through the display screen, but also provides haptic information through a physical external shape variation. Therefore, the haptic and visual information providing apparatus may provide a user with a feeling which seems like touching an actual button. That is, the feeling described in this embodiment means a feeling, for example, a click feeling which a user may detect when the physical external shape of an object is varied by a user's force or the like.

In accordance with the embodiment of the present invention, the haptic and visual information providing apparatus and method may provide visual information and haptic information through the display screen at the same time. Furthermore, when a key button or the like is selected, the haptic and visual information providing apparatus and method may provide a user with a feeling which seems like touching an actual key button, by providing visual information and haptic information.

While the present invention has been described with respect to the specific embodiments, it will be apparent to those skilled in the art that various changes and modifications may be made without departing from the spirit and scope of the invention as defined in the following claims.

What is claimed is:

1. A self-morphable haptic and visual information providing apparatus comprising:
a display unit configured to provide haptic information through a physical shape variation of a display screen; and
a haptic element driving unit configured to generate a driving signal for providing the haptic information.

2. The self-morphable haptic and visual information providing apparatus of claim 1, wherein the display unit comprises a haptic element array configured to operate in response to the driving signal, and
the haptic element array includes at least one haptic element to provide the haptic information.

3. The self-morphable haptic and visual information providing apparatus of claim 2, wherein the display unit further comprises:
a touch sensor layer configured to generate a user input signal according to a user's touch; and
a visual display layer configured to provide visual information.

4. The self-morphable haptic and visual information providing apparatus of claim 3, wherein any one of the touch sensor layer and the visual display layer is positioned over a haptic sensor, and has such a flexible structure as to provide haptic information according to an operation of the haptic sensor.

5. The self-morphable haptic and visual information providing apparatus of claim 4, further comprising a control unit configured to control the haptic element driving unit to drive haptic elements corresponding to the visual information displayed through the visual display layer.

6. The self-morphable haptic and visual information providing apparatus of claim 5, wherein the visual information comprises key button information which contains information on at least one of a menu key, a function key, a number key, a character key, a special key, a special character key, and an arrow key.

7. The self-morphable haptic and visual information providing apparatus of claim 3, wherein the haptic element operates in a direction perpendicular to the display screen.

8. The self-morphable haptic and visual information providing apparatus of claim 7, wherein the haptic element comprises a linear actuator, and
the linear actuator comprises:
a transducer configured to perform a repetitive movement in a vertical direction according to the driving signal;
a movable shaft configured to reciprocate in the vertical direction according to the repetitive movement; and
a rotor configured to move on the movable shaft along the movable shaft.

9. The self-morphable haptic and visual information providing apparatus of claim 8, wherein the haptic element comprises an electro active element, and
the electro active element comprises:
an electro active material of which the size changes according to the driving signal; and
an elastic element which is attached to the surface of the electro active material and of which the height is elastically changed in the vertical direction.

10. The self-morphable haptic and visual information providing apparatus of claim 3, wherein the haptic element comprises a visual display element which is combined to display the visual information.

11. A self-morphable haptic and visual information providing method comprising:
detecting that haptic information is to be provided through a display screen;
selecting haptic elements to provide the haptic information, when the providing of the haptic information is detected;
generating driving signals for driving the selected haptic elements; and
driving the selected haptic elements according to the driving signals and providing haptic information through a physical shape variation of the display screen.

12. The self-morphable haptic and visual information providing method of claim 11, further comprising simultaneously providing visual information corresponding to the haptic information through the display screen.

13. The self-morphable haptic and visual information providing method of claim 12, wherein the visual information comprises key button information which contains information on at least one of a menu key, a function key, a number key, a character key, a special key, a special character key, and an arrow key.

14. The self-morphable haptic and visual information providing method of claim 11, wherein said driving the selected haptic elements according to the driving signals and providing the haptic information through the physical shape variation of the display screen comprises driving the haptic elements in a direction perpendicular to the display screen and providing the haptic information through a physical shape variation of the display screen.
